(19) United States
(12) Patent Application Publication
(10) Pub. No.: US 2013/0204713 A1
(43) Pub. Date: Aug. 8, 2013

(54) Cyber classified free standing insert system and method

(71) Applicant: Alan Snedeker, Glens Falls, NY (US)

(72) Inventor: Alan Snedeker, Glens Falls, NY (US)

(21) Appl. No.: 13/385,199

(22) Filed: Feb. 7, 2012

(51) Int. Cl. G06Q 30/02

(52) U.S. Cl. 705/14.72; 705/14.4

(57) ABSTRACT

A cyber classified free standing insert system and method enables one or more advertisers to buy and schedule advertisement ads. The advertising ads have cyber content accessible by a user/consumer using an electronic device. The system comprises a printed page advertising medium. At least one specialized main body heading related to a specific category, or non-specific category of goods or services is located on the printed page. At least two non-competing advertisement blocks are located on the printed page directly next to one another and the cyber content. The non-competing advertisements fall within the type of category of goods or services indicated in the main body heading. The cyber content section contains the cyber content on the printed page directly next to the advertisements. The cyber content section includes a unique website link associated with each of the non-competing advertisements and other links, i.e. advertiser's website.

### BACKGROUND OF THE INVENTION

1. Field of the Invention

The present invention relates to electronic marketing systems; and, more particularly to a computer-linked marketing system and method comprising marketing and advertising tools especially tailored to electronically provide free standing inserts and advertising circulars.

2. Description of the Related Art

A large portion of a companies' budget is spent on advertising costs. Advertising costs vary substantially, depending on the amount of circulation and on the advertising vehicle. Small businesses, including book publishers and self publishing book authors, artists, consultants, some professionals, musical groups small manufacturing businesses, re-manufacturers, photo services, catalog merchandisers, direct marketers, companies and individuals that sell on e bay and Amazon and unusual services have very limited opportunity to sell their wares broadly and without facing stiff competition and heavy ad costs. Small business owners, entrepreneurs and creative's such as authors; bands; and the like, are regularly confronted by the dilemma: “How do I get my product or company noticed?” and “How do I build traffic to a web site when everyone is using the same techniques?” Additionally “How can I brand my service or product if it takes multiple exposures of my brand for people to recognize it and trust it.”?

Conventional advertising vehicles have included digital medium on the Internet (such as buying a Google® ad or search engine ad), television and radio, printed medium in magazines, newspapers, flyers, and mail circulars.

One common problem encountered with each of these vehicles is the relatively high cost thereof to attract attention to the specific product or service or Internet location. Despite the expense, an advertiser can readily get lost in the shuffle as competitive products or services typically appear next to one another. For example, when buying a search engine ad on the Internet, an advertiser's goods or services are uncovered when a person searches a given goods/services category. However, the advertiser's goods or services are also shown on a search engine result page along with a host of competitive goods or services. The ad itself can be expensive and oftentimes, unless the advertiser is willing to pay a premium, the advertisement may not even show-up on the first of many search engine results pages, since there may exist a vast number of third party advertisements for substantially the same goods/services. If one markets on-line a generally unknown product or service, the ability to attract attention to the web site that sells that product or service is generally not possible without added expense that increase with the number of competitive suppliers of the same kind of product. Research shows that being on page 2 of a web search is like not having been on the web site at all. Only 1% to 2% of searchers will look at page two, meaning that 98-99% of whatever monies were spent to gain viewers are totally wasted, in an environment of competitive products. http://searchenginewatch.com/article/2049695/Top-Google-Result-Gets-36.4-of-Clicks-Study. In fact the top 3 positions in a web site account for almost 60% of the click-throughs.

Another conventional advertising vehicle is that of free standing inserts (FSI) or circulars and other printing advertising mediums that are printed advertisements intended for mass distribution to consumers. Distribution can reach 72 million households every week. These printed advertisements generally include a full or half page print ad that usually includes a coupon and/or another standard promotion like a sweepstakes or refund. Current cost structures for these vehicles allow an advertiser or business to purchase either a full page or half page ad at estimated rates of ˜$5.00 per thousand and ˜$2.50 per thousand, respectively, for example.

Implementation of the Internet and the World Wide Web has facilitated creation of a number of advertising techniques.

The art appreciates that there exist many constraints on an advertiser's ability to locate media outlets within which to advertise. In addition, it is recognized that there exist constraints on the location of affordable advertising outlets. Most small companies cannot afford to advertise broadly because of budget cannot meet the dollar demands created by the high cost of traditional media. The presence of these constraints is particularly troublesome for advertisers who are in very competitive market. In such competitive markets there are oftentimes present a vast array of advertisers offering substantially similar or even the same product, which tends to dilute the effectiveness of an advertisement.

Accordingly, there exists a need in the art for a system and method that provides advertisers, primarily who do not sell at retail, with the ability to purchase small advertising space on a single page or source via free standing inserts with non-competing advertisements/or non-competing businesses/products/services. There also exists a need in the art for non-competing advertisements to be related or correlated with one another, to drive customers to the relating goods and/or services. Further, there exists a need in the art for a system and method that enables a plurality of non-competing advertisers to share a single page via a circular page or free standing insert to allow cost-sharing and drive consumer purchases. Lastly, there exists need in the art for a single page or source with a free standing insert that is associated with a cyber source or link where consumers are directed and can link to and purchase or view non-competing advertisements.

### SUMMARY OF THE INVENTION

Establishing brand awareness and sustaining recognition in a competitive market represent a significant hurdle for any company. The present invention provides the wherewithal for a company to clear this hurdle by enabling advertisers to locate (i) media outlets in which to advertise, and (ii) overcome constraints on finding affordable advertising outlets. In accordance with the invention, there is provided a venue for advertisers in a very competitive market containing a vast array of advertisements for a variety of substantially similar or the same products.

The present invention is configured to maximize advertising revenue as the advertisers share advertising space with non-competing yet related goods and/or services. Advertisers sharing the page receive cost sharing benefits, and encounter less competition on the advertising page.

For example, for the free standing inserts (FSI) distribution medium: The present invention is configured to maximize advertising revenue for the FSI company, because total revenue per page is higher than the revenue generated by standard half and full page FSI ads. At the same time, the advertisers have cost savings. The advertisers share advertising space with non-competing yet related goods and/when advertised with a category headline such as “Awesome Auto Accessories” (exclusive category products and services) or non related goods and services with a generic theme or category headline such as “Sally's Savings” (inclusive category products and services).

Advertisers sharing the page receive cost sharing benefits, and encounter less competition on the advertising page. As a result, an advertiser attains greater visibility on the page and the advertisement is not diluted by the presence of competing products/or services.

In one aspect, the present invention provides a cyber classified free standing insert system for enabling one or more advertisers to buy and schedule print or digital advertisements with cyber content thereon. The cyber content is accessible by a user/consumer using an electronic device having the capability (i) to receive and transmit messages, (ii) accept input via a user interface, and (iii) display messages on an electronic display. The cyber classified free standing insert comprises a printed page advertising medium. “Printed page” as used herein includes any known fixation of material, including in digital form and/or in hard-copy form. At least one specialized main body heading related to a specific category of goods or services, or a generic theme that links a variety of products or services is located on the printed page. Referring to a half page ad, at least two non-competing advertisement blocks are located on the printed page directly next to one another, and the cyber content. The number of advertisement blocks contemplates for example, two advertisers in a half page ad could pay half or more than half, but less than the full half page price, and still save money, and FSI company still profit. More than two advertisement blocks—such as eight for a full page are also contemplated. The non-competing advertisements fall within the specific category of goods or services of the specialized main body heading or fall within a variety of goods under a generically themed main body heading. The cyber content section contains the cyber content on the printed page directly next to the advertisements. The cyber content section includes a unique website link associated with each of the non-competing advertisements. The system comprises a computer-implemented advertising network including a server that contains the cyber content and has a database adapted to transmit and receive messages from the user's electronic device. An option is included in a coupon or headline area to list one web site that accesses all advertiser sites, and/or that simply re-lists the links that appear in each advertiser's advertisement.

In another aspect, the invention provides a method for enabling a user/advertiser to buy and schedule advertisement blocks on a free standing insert. The method provides a cyber classified free standing insert method for enabling one or more advertisers to buy and schedule advertisements. These advertisements have cyber content thereon. The cyber content is accessible by a user/consumer using an electronic device having the capability to (i) receive and transmit messages, (ii) accept input via a user interface, and (iii) display messages on an electronic display. The method comprises the steps of: (a) forming a printed page advertising medium; (b) inserting at least one specialized main body heading related to a specific category of goods or services on said printed page, or a main body heading that can accommodate a variety of unrelated products/services; (c) selecting/creating at least three non-competing advertisement blocks located on said printed ½ page (at least 5 advertisers for a full printed page) and being directly next to one another, said non-competing advertisements falling within said specific category of goods or services of said specialized main body heading, or representing variety of goods and services linked by a generic main body heading; and (d) providing a cyber content section containing said cyber content on said printed page directly next to said advertisements, wherein said cyber content section includes a unique website link associated with each of said non-competing advertisements.

The above and other aspects, features and advantages of the present invention will become apparent from the following description when read in conjunction with the accompanying drawings, in which like reference numerals designate the same elements.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 illustrates a schematic view of an embodiment of the subject invention, showing a novel free standing insert;

FIG. 2 is a flow chart of an embodiment of the cyber content free standing insert system and method;

FIG. 3a is a flow chart illustrating the “Heading Categories”/specialized main body heading related to a specific category of goods or services, and optional sub-categories leading to the placement of non-competing yet related advertisements on the same FSI page, and/or optional generic themes;

FIG. 3b is a flow chart illustrating an example of “Generic Categories” specialized main body headings related to a generic category of goods or services, and optional sub-categories leading to the placement of non-competing yet related advertisements on the same FSI page; and

FIG. 4 is a flow chart illustrating an embodiment of the CCFSI system and method.

### DETAILED DESCRIPTION OF THE INVENTION

A novel marketing system and method is provided by the subject invention. Companies/individuals are offered the opportunity to engage with consumers in a forum, preferably comprising a free standing insert or circular wherein non-competing yet related advertisements are provided. As marketers, companies need to choose a variety of marketing platforms—online and offline—that work together to create the best mix for their target consumers. Currently, marketing services can cost hundreds of thousands of dollars and several weeks to orchestrate. The subject system and method provides a unique integrated marketing approach that is appointed to attract consumers and engage consumers on media platforms. Among available print products it is adapted to yield one of the highest rates of readership of advertisements because of the nature of most of the advertisements which provide savings to consumers. Advantageously, the subject system and method provide the opportunity for an advertiser to purchase a smaller page portion, i.e. at a lesser cost than traditional fees attending to full page or half page FSI ads, and less than all traditional magazine and newspaper ad rates, while also allowing the advertiser to advertise on a page that exclusively contains non-competing advertisements.

The system and method provides advertisers with the ability to purchase small advertising space on a single page or source by way of a free standing insert with non-competing advertisements/or non-competing businesses. These non-competing advertisements can be related or correlated with one another to drive customers to the relevant goods and/or services, thereby increasing the likelihood of impulse purchasing. Advertisers can be random, or inclusive businesses and products tied to a generic theme, or category related products tied to a category specific theme. Additionally, the system and method affords a plurality of non-competing advertisers the ability to share a single page by way of a circular page or free standing insert that allows cost-sharing and drives consumer purchases and help increase brand recognition. The single page or source created by the free standing insert of the subject invention is associated with a cyber source or link, where consumers are directed to, and/or can link to and purchase or view the non-competing advertisements. The cyber content directs consumers to a URL link wherein each of the non-competing advertisement's features appears on the website. Advantageously, this provides ready access to information facilitating purchase of the goods/services, as well as additional information or marketing promotional material such as coupons, rebates, free samples, instructional videos, promotional literature, gift giveaways and/or direct links to the advertiser's web pages.

In addition it is known that when faced with multiple buying options that consumers can get stressed and confused. That is partly reflected in the fact that almost 60% of click-throughs in an Internet search are accounted for by the first three items on the first page. Internet clicks study source: http://searchenginewatch.com/article/2049695/Top-Google-Result-Gets-36.4-of-Clicks-Study.

Reduced option benefits are also reflected in the success of stores, such as those under the trade names Trader Joes and Aldi which offer consumers limited choices resulting is quicker buying decisions and faster shopping, and simpler logistics and shelf maintenance for the companies. The non-competitive natures of the cyber FSI takes advantage of consumer desires to view products in a reduced competitive environment.

The subject invention helps build small to medium sized businesses by giving them broad exposure to approximately one million households for about $1,000 for full color advertisements. For example to reach 150,000 consumers in Springfield Mass. would cost only $150 plus production expenses. All of this in a non-competitive environment in a widely read FSI.

The subject system and method provides an advertising circular having thereon a plurality of non-competing advertisements associated with cyber content. Also provided is a method of making and using a cyber classified, free standing insert system. The cyber classified system sells a plurality of ads (preferably 8 ads) on a page or same surface that includes cyber content thereon. In doing so, the cyber-classified system directs or drives traffic to the advertisers' websites at a significantly lower cost.

For example, because the advertisers can buy a single block on a single page of 8 blocks, the cost to the advertiser is a fraction of the cost of a half-page or full-page ad.

Whereas a half-page and/or full page add generally runs for $2.50 to $5.00 per thousand, through use of the subject system and method the cost could be lowered to ˜$1.00 per thousand. As a result, the page itself offers a significant revenue increase to the circular company. Instead of simply selling half-page or full-page blocks on a single page, the circular company can now sell eight separate blocks on a single page. Page revenue in the aforementioned example is increased from $5000 per million circulations to $8000 per million circulations. This amounts to a 60% increase in page revenue. Advantageously, the advertiser company will be able to buy additional advertising blocks in the future since the cost thereof is decreased from $2.50-$5.00 for half-page or full-page ads to $1.00 for a ⅛^{th} page ad. Small budgets will reach more consumers. The cost to reach any one home with a full color ad is around one tenth of one cent. A one thousand dollar media purchase in the Cyber FSI will reach one million households.

By comparison the average magazine charges $40 per thousand for a full-page advertisement. To reach one million customers would cost $40,000 (Forty thousand dollars). The difference allows a small company to buy a Cyber FSI advertisement and reach $40,000 dollars worth of exposure for 2.5% of a common print media page buy, or $1,000. This will stimulate new business for the small to medium companies and will help the economy grow.

The ability to purchase a smaller portion of the page reduces the cost to a comparatively nominal amount, while cost-savings are shared for each of the advertisers on the page. For example, in the case where a full page ad costs $5.00 per thousand, an advertiser can instead purchase a one inch add on the page, thereby sharing the page with seven other non-competing advertisers and encountering approximately ⅕^{th} of the cost of a full page single product or company ad. At the same time, the CYBER FSI page provider can charge even as little as $1.00 per one inch add and receive $8.00 per thousand for the full-page ad from the eight advertisers. As a result, the page provider can realize a larger advertiser base as well as an increase from just $5.00 per thousand from a single advertiser to $8.00 per thousand or more per page for eight advertisers sharing the cost.

The subject free standing insert provides a heading or subject matter category for each free standing insert page. The advertiser's goods/services fall within the given heading or subject matter category. For example, the heading or subject matter category on the free standing insert may be for beauty products. Each of the non-competing advertisers is thus categorized as being advertising goods/services relating to beauty products, but not overlapping in the same type of product. One advertisement may be directed toward foundation; another may be directed toward press powder finishes; another may be directed toward eye make-up; another towards blush; another toward lip stick or lip gloss; another toward a facial scrub treatment for preparing the face surface; and/or another toward a lip nourishment treatment or the like. Another example involves children's goods/services, wherein one advertisement may be directed toward arts and crafts for children; another toward dance lessons or children's classes; another towards children's magazines; another towards children's food items; another toward children's games or activities/clothing.

Alternatively, the subject free standing insert can provide a generic heading or headline for each free standing insert page that does not represent any one product or service category. The advertiser's goods/services fall within the generic heading that can encompass many unrelated products. For example, the heading or subject matter category on the freestanding insert might state “Fall Family Fun Savings!”

One advertisement may be directed toward an amusement park; another tickets to a football game, or an ice cream cone sale, a free visit to a local Y, movie tickets discounts, a motel room during peak fall color weeks, DVD car games, and a Fall Foods cook book.

Another subject block might read “Sally's Selections which would show a variety of new products or services that are totally unrelated in function, such as new kitchen tool, a sightseeing train ride, a car safety device, an organic honey, a piano course, a new lighting system, and a new message center for the home.

The subject invention offers to sell non competing space to companies and individuals who have a product or service to sell. Preferably, space is offered at a Cost per Thousand (CPM) distribution for a one inch full-color cyber FSI. The space is pre-themed to attract customers from a specific category of goods or services (Like Auto accessories) or pre-themed with a generic theme that will allow totally unrelated products and services to advertise. Such a generic them may for example be a clearance, or on-sale theme, or other theme. Conversely the cyber FSI could be themed based on space sales and participant preferences which would allow a participant to decide if his product or service is categorized or not. Use of the subject system will make sure that no two participant products or services provide the same function in any one cyber FSI. Some products like books have different markets that are basically non competitive as long as only one book for each category is accepted. For example books can be Non Fiction Teen, Non fiction Adult, Board books, Early reader books etc. One book from each category would not be considered in conflict with the non competitive nature of the subject cyber FSI as the audience for each book is different. Someone who likes science fiction would be unlikely to choose a board book and vice versa. Product category competitive definitions are predetermined by the subject system, and prospective buyers have a right to decline being in a category specific cyber FSI. The system clears each of cyber FSI participants with the media that will distribute the FSI. Any potential surcharges from the FSI carrier will be reported to the participant who can decline to advertise with the additional cost, or can drop out.

The subject system provides each cyber FSI with a given heading or theme that will accommodate the nature of the participant's products or services. The theme can appear outside the individual advertisements, or within a coupon. Each ad will carry the participant website links, or a universal link to a web site that has all participant web site links. (At some point this might have a product sales element.) The coupon can be used to provide distinct URL's for each participant, or might contain one universal link to all a participant advertiser's website links. The coupon can contain rebates or coupon codes, or sweepstakes or other common promotions or promotional elements. It can also be used to direct readers to look for promotions at each participant's web site.

Depending how the final product is structured, the subject system will monitor click-through to provide sales, product, and customer research in support of building the small and medium sized business which it is targeting. For large companies, the subject system is appointed to be useful as a new low cost product or product concept test.

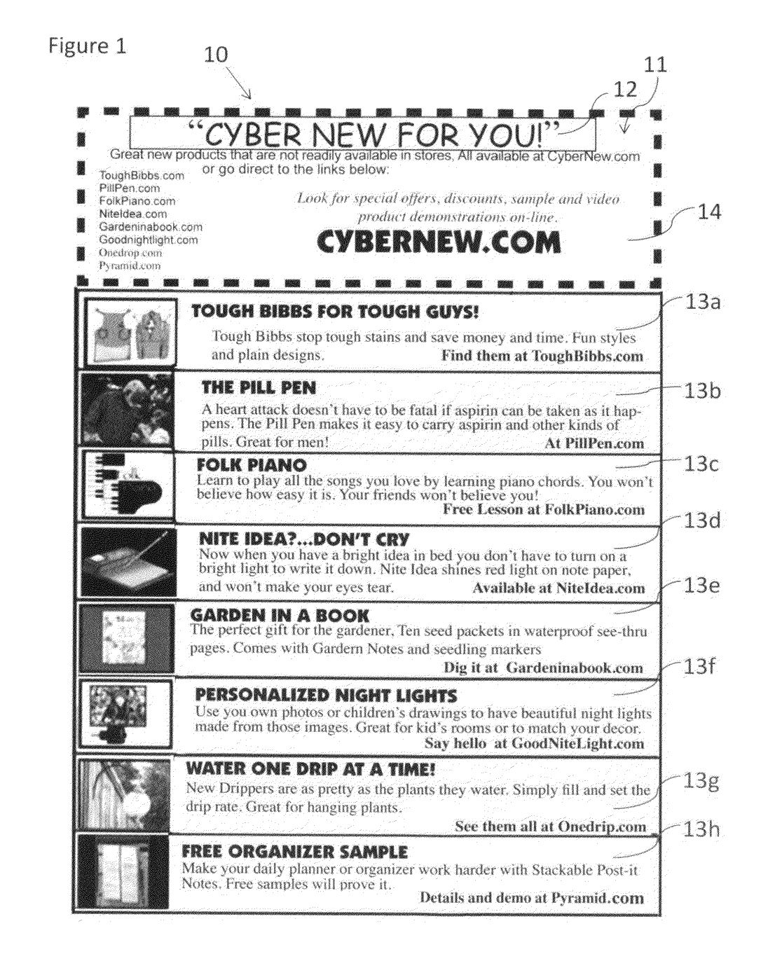

FIG. 1 illustrates an embodiment of the subject invention. As used herein the subject Cyber Classified Free Standing Insert shall be referred to as the “CCFSI”. The CCFSI is shown generally at 10. The CCFSI provides a free standing insert (“FSI”) 11/printed medium page. The FSI is appointed to be placed in a flyer, magazine, newspaper, mailer, circular, or as a free standing insert at an establishment. Alternatively, the FSI is in digital form. Preferably, the FSI 11 includes a specialized main body heading 12. Herein the main body heading 12 is directed to “Cyber New for you” great new products not readily available in stores. The main body heading 12 is shown at the top of the FSI 11, but may appear at the bottom of the FSI 11 page or on any other viewable location of the FSI 11 page. The FSI 11 further includes eight advertisements for goods/services that are not related to one another, and are non-competing, as shown at 13a-n. Herein, eight different advertisements 13a-13h are provided, with each advertisement 13a-13h taking-up a ˜1 inch space on an 8×11 FSI 11 page. Alternatively, the FSI 11 may instead be a half of a page/or less than a normal page height, and in which case there may be 3 or 4 advertisements 13 on the page. Optionally, the page is a full page and there are five to ten non-competing advertisement blocks located on the page and being directly next to one another. Most preferably, there are eight non-competing advertisement blocks located on a full page FSI. Wherein the page is a half page, there are preferably two to five non-competing advertisement blocks located on the page and being directly next to one another. Most preferably, there are three non-competing advertisement blocks located on a half page FSI.

Each advertisement 13a-13h falls within the subject matter of the main body heading 12. Each advertisement 13a-13h is related within the same subject matter of the main body heading 12, and is not competitive. Depending on the body heading 12 products or services could fall under a category like “auto” with related but non competitive products. The FSI 11 further includes a contents section 14. Contents section 14 preferably provides an FSI website that in turn advertises the subject advertisements 13a-13h and provides a link to a URL for each of the companies of the advertisements 13a-13h. The contents section 14 may include/comprise coupons, a website, discounts and/or listing of separate URLs directly to each of the companies/advertisements 13a-13h websites, or a single website that provides access to all advertiser links.

Advantageously, the subject CCFSI allows small business manufacturers, service providers and authors and artists to reach 1,000,000 households in four-color advertising, for $1000. This would be novel in today's market, giving web site owners a chance to reach millions of potential customers in a competitively free media versus consumer product searches in Google, E bay, and Amazon, which usually list all competitive products. The CCFSI provides advantages to the advertisers, the consumers and advertiser outlets and platforms. Instead of selling page, and half page ads typically containing store coupons, and mail-in order forms, the subject CCFSI provides a vehicle to sell one inch ads to eight different businesses per page, (3-4 for half page). The prime purpose of the ads is to drive traffic to advertiser web sites where products and services can be sold. A secondary purpose is to build the brand and develop relationships with consumers.

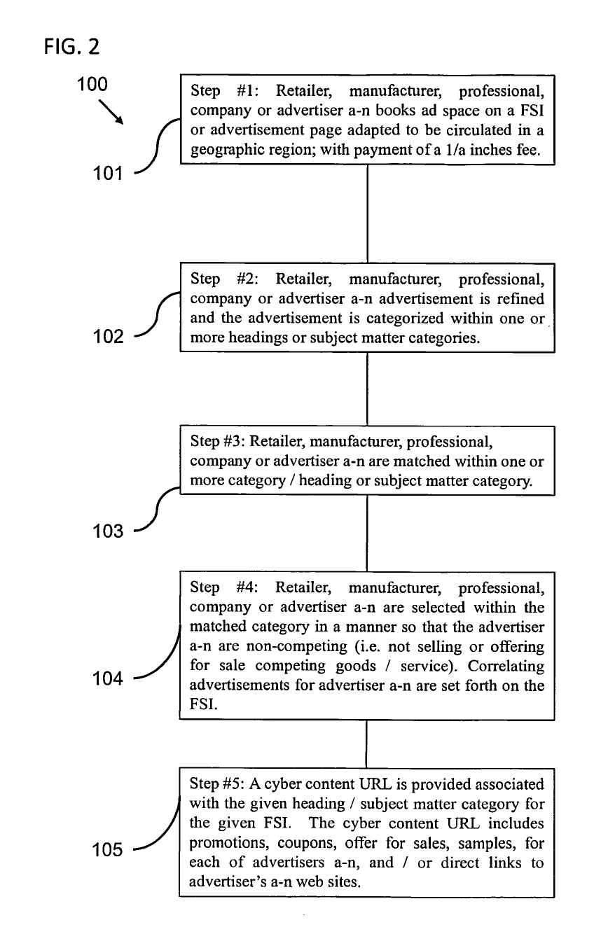

FIG. 2 is a flow chart of an embodiment of the CCFSI, shown generally at 100. Referring to FIG. 2, in step #1 at 101 the user/retailer, manufacturer, professional, company or advertiser a-n books ad space on a FSI or advertisement page adapted to be circulated in a geographic region with payment of a 1/a-n inches fee. In step #2 at 102, the retailer, manufacturer, professional, company or advertiser's a-n advertisement is refined and the advertisement is categorized within one or more headings or subject matter categories. In step #3 at 103, the retailer, manufacturer, professional, company or advertiser a-n are matched within one or more category/heading or subject matter category. In step #4 at 104, the retailer, manufacturer, professional, company or advertiser a-n are selected within the matched category in a manner so that the advertiser a-n are non-competing (i.e. not selling or offering for sale competing goods/service). Correlating advertisements for advertiser a-n are set forth on the FSI. In step #4 at 5, a cyber content URL is provided associated with the given heading/subject matter category for the given FSI. The cyber content URL includes promotions, coupons, offer for sales, samples, for each of advertisers a-n, and/or direct links to advertiser's a-n web sites.

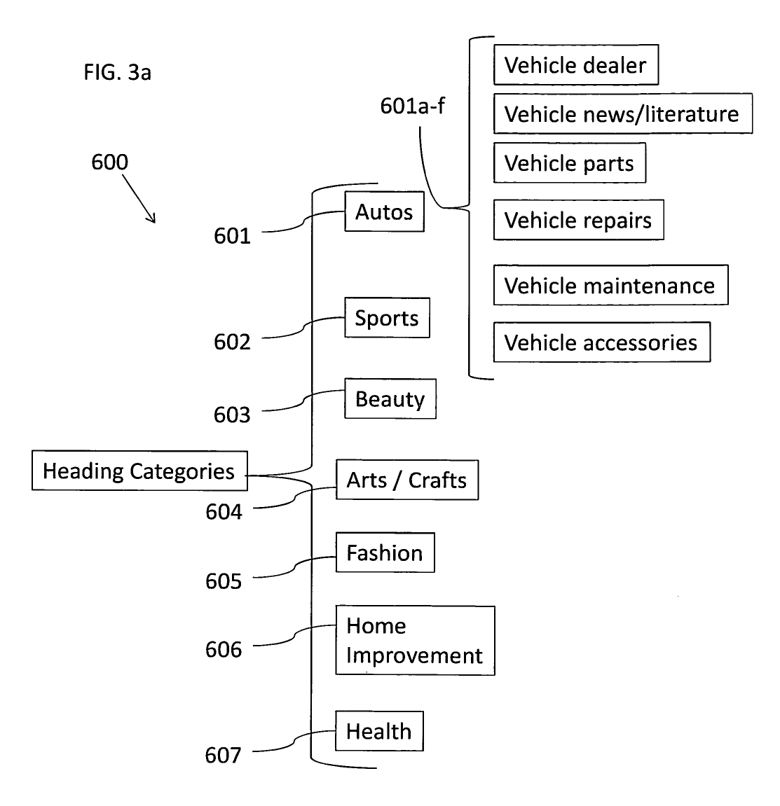

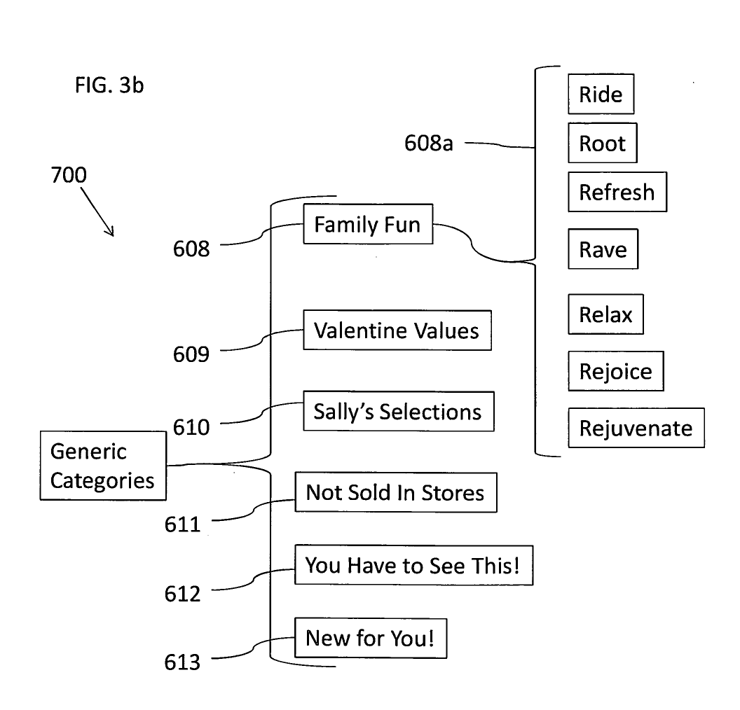

FIG. 3a is a flow chart illustrating an example of “Heading Categories” specialized main body headings related to a specific category of goods or services, and sub-categories leading to the placement of non-competing yet related advertisements on the same FSI page, shown generally at 600. FIG. 3b is a flow chart illustrating an example of “Generic Categories” specialized main body headings related to a generic category of goods or services, and sub-categories leading to the placement of non-competing yet related advertisements on the same FSI page.

Referring to FIG. 3a, “Heading Categories” or specialized main body heading related to a specific category of goods or services are provided, including for example “Autos” 601, “Sport” 602, “Beauty” 603, “Arts and Crafts” 604, “Fashion” 605, “Home Improvement” 606, and “Health” 607. These “Heading Categories” only represent a sampling of the intended categories, many more or other different categories can be provided. In turn, each “Heading Categories” or specialized main body heading related to a specific category of goods or services 601-607 could include sub-categories, for example shown at 601a-f. More themes and/or sub-categories may be provided. Cyber content on each FSI is unique to the given FSI and advertisers thereon and, consequently, the given heading category.

Referring to FIG. 3b, generic headings under which products and services of an unrelated nature can instead/or also be listed. Examples include “Family Fun” 608, “Valentine Values” 609, “Sally's Selections” 610, “Not sold in stores” 611, “You have to see this!” 612 and “New for you” 613. Sub categories 608a may be provided that refer to the heading. An advertisement for example may refer to “Ride! Root! Refresh! Rave! Relax! Race! Rejoice! and Rejuvenate!”—“Ride” (amusement park discount,) “Root” (football tickets), “Refresh” (ice cream cone sale), “Rave” (movie discounts), “Relax” (spa discount), “Race” (car games), “Rejoice” (Fall Colors Motel discount) and “Rejuvenate” (a free Y visit).

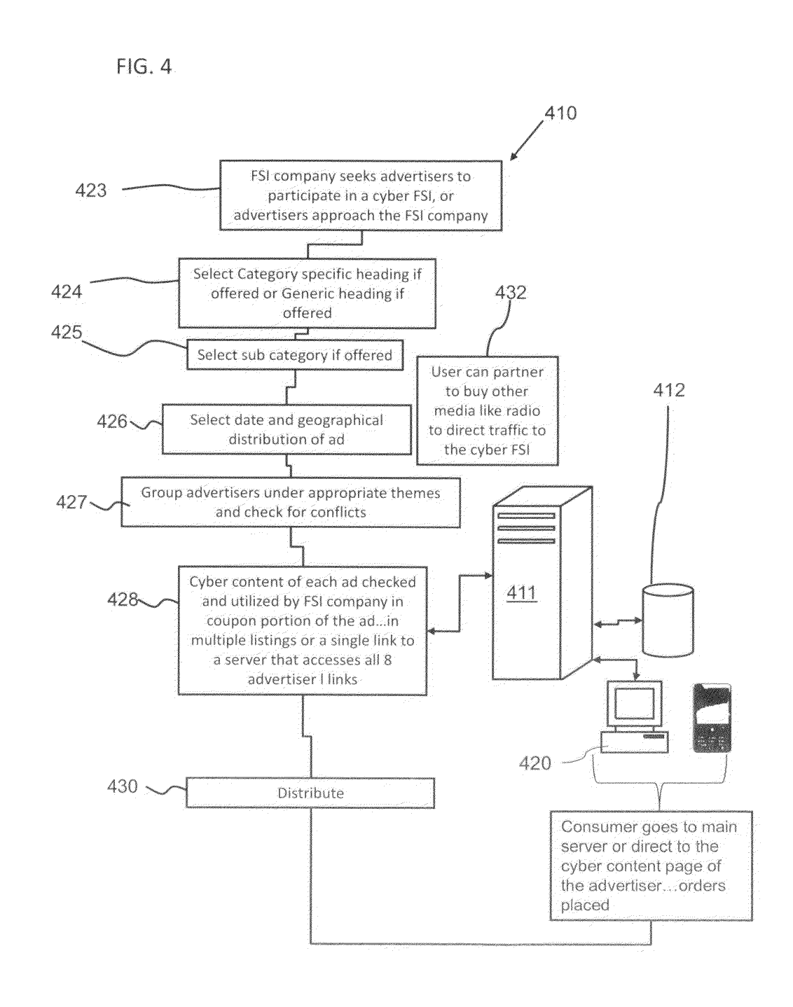

FIG. 4 is a flow chart illustrating an embodiment of the CCFSI system and method, shown generally at 410. The CCFSI enables a user/advertiser to buy an advertising block on a FSI. The advertiser requests, schedules and purchases the advertising block space on the FSI at 423. The advertiser's advertisement is placed or associated with a select heading or category ad at 424 and is further selected within a sub category within the main heading category at 425. Selected geographical region and date of ad are provided at 426. Match of advertisers is accomplished by selecting from the same heading but within different sub categories to avoid overlap/competitive ads. In this manner there is formed at 427 a FSI with 4-8 advertisers. Creating cyber content directed to each of the advertisers on the FSI is provided at 428. The cyber content is linked to web sites of the advertisers on the FSI at 429. After finalizing the FSI, the FSI is distributed to consumers at 430. The CCFSI includes cyber content directing consumers to a unique web site link which contains information and promotional materials regarding the non-competing advertisements a-n thereon. The system cyber content website includes stored information on a server 411 associated with a CPU having a database 412 adapted to transmit and receive messages from a user's/consumer's 420 electronic device.

Advantageously, advertisers can link promotions on the CCFSI to its own website. Further, users can join together to share advertising costs and/or to offer related products or services for sale on the FSI. Preferably, the cyber content is directed to a computer-implemented advertising platform including a server with a database adapted to transmit and receive messages from the user's/consumer's electronic device. The cyber content includes a unique website URL associated specifically with the given FSI. The cyber content may include a smart phone or pad application link or text. Preferably, the cyber content comprises a website URL which in turn includes a direct link URL to each of the advertisement's websites. What is more, the cyber content may include at least one coupon, samples, gifts and other promotions.

The printed page advertising medium may be a free standing insert in a tangible medium, such as a paper flyer or insert/money mailer or circular that is manually distributed. What is more, the printed page advertising medium may be a poster or billboard, signage, or screen. Alternatively, the printed page advertising medium may be in digital form.

Preferably, there are at least three non-competing advertisement blocks located directly next to one another on the printed page. In other words, the blocks are on the same page as one another forming the FSI. Preferably, there are four non-competing advertisement blocks being located on the printed page directly next to one another. Most preferably, there are eight non-competing advertisement blocks located directly next to one another on the printed page. The non-competing advertisements are preferably related to one another, falling within the same heading or category. Each non-competing advertisement block may include a direct web site link therein.

The printed page advertising medium may be a typical paper page, being about 8 inches×11 inches. In which case, where there are at least four of the non-competing advertisement blocks available for purchase by an advertiser, each of the blocks ranges from about 1 inch to 2 inches in height. In the case where there are at least eight of the non-competing advertisement blocks available for purchase by an advertiser, each of the blocks ranges from about 0.5 inches to 1 inch in height.

Having described the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A cyber classified free standing insert system for enabling one or more advertisers to buy and schedule advertisement blocks and having cyber content thereon accessible by a user/consumer using an electronic device having capability (i) to receive and transmit messages, (ii) accept input via a user interface, and (iii) display messages on an electronic display, the system comprising:
a. a printed page advertising medium;
b. at least one specialized main body heading or theme related to a specific category of goods or services, or a generic heading for unrelated products and services, being located on said printed page;
c. at least two non-competing advertisement blocks located on said printed page being directly next to one another;
d. said non-competing advertisements falling within said specific category and/or said generic category of goods or services of said specialized main body heading; and
e. a cyber content section containing said cyber content on said printed page directly next to said advertisements, wherein said cyber content section includes a unique website link.

2. A cyber classified free standing insert system as recited by claim 1, wherein said unique website link is associated with each of said non-competing advertisements.

3. A cyber classified free standing insert system as recited by claim 1, wherein said unique website link is associated a single link that allows consumers to access all advertisers in a specific cyber classified free standing insert.

4. A cyber classified free standing insert system as recited by claim 1, wherein said cyber content is directed to a computer-implemented advertising platform including a server with a database adapted to transmit and receive messages from said user's/consumer's electronic device.

5. A cyber classified free standing insert system as recited by claim 1, wherein said cyber content comprises a website URL.

6. A cyber classified freestanding insert system as recited by claim 1, wherein said cyber content comprises a smart phone or pad application.

7. A cyber classified free standing insert system as recited by claim 1, wherein said cyber content comprises a website URL which in turn includes a direct link URL to each of said advertisement's websites.

8. A cyber classified free standing insert system as recited by claim 1, wherein said cyber content comprises at least one coupon, samples, and other promotions.

9. A cyber classified freestanding insert system as recited by claim 1, wherein said printed page advertising medium is a freestanding insert.

10. A cyber classified freestanding insert system as recited by claim 1, wherein said printed page advertising medium is in tangible paper form.

11. A cyber classified freestanding insert system as recited by claim 1, wherein said printed page advertising medium is in digital form.

12. A cyber classified free standing insert system as recited by claim 1, wherein there are at least three non-competing advertisement blocks located directly next to one another on said printed page.

13. A cyber classified free standing insert system as recited by claim 1, wherein there are four non-competing advertisement blocks being located on said printed page and being directly next to one another.

14. A cyber classified free standing insert system as recited by claim 1, wherein said page is a full page and there are five to ten non-competing advertisement blocks located on said page and being directly next to one another.

15. A cyber classified free standing insert system as recited by claim 1, wherein said page is a half page and there are two to five non-competing advertisement blocks located on said page and being directly next to one another.

16. A cyber classified free standing insert system as recited by claim 1, wherein said specialized main body heading includes goods/services selected from the group such as automobiles, kids, teens, babies, education, cosmetics, beauty, health, fitness, and sports, music, arts, books—fiction and non-fiction, and movies etc.

17. A cyber classified free standing insert system as recited by claim 1, wherein said generic main body heading includes allows non-related products and services representing multiple categories to be advertised such as Family Fun, Valentine Values, Sally's Selections, Not sold in stores, You have to see this! And New for you”.

18. A cyber classified freestanding insert system as recited by claim 1, wherein said non-competing advertisements are related to one another by category or theme.

19. A cyber classified freestanding insert system as recited by claim 1, wherein each of said non-competing advertisement blocks includes a direct web site link therein.

20. A cyber classified free standing insert system as recited by claim 1, wherein said printed page advertising medium is about 8 inches×11 inches.

21. A cyber classified free standing insert system as recited by claim 20, wherein there are two to eight of said non-competing advertisement blocks available for purchase by an advertiser and each of said blocks ranges from about 1 inch to 2 inches in height.

22. A cyber classified free standing insert system as recited by claim 20, wherein there are two to eight of said non-competing advertisement blocks available for purchase by an advertiser and each of said blocks ranges from about 0.5 inches to 1 inch in height.

23. A cyber classified free standing insert system as recited by claim 1, wherein said cyber content comprises at least one promotion such as a price offer, coupon or other available promotions.

24. A cyber classified free standing insert system as recited by claim 1, wherein said advertising medium comprises a spread contained on two adjacent pages and having a single heading and coupon.

25. A cyber classified free standing insert system as recited by claim 1, wherein said advertising medium comprises a separate multi-page insert consisting of cyber advertisements.

26. A cyber classified free standing insert system as recited by claim 1, said advertising cyber content being devoid of a theme or a coupon and comprising a separate web address for each advertiser.

27. A cyber classified free standing insert system as recited by claim 1, said advertising cyber content being devoid of a theme or a coupon and comprising a common web address wherein all advertisers can be accessed

28. A cyber classified free standing insert method for enabling one or more advertisers to buy and schedule advertisement spots and having cyber content thereon accessible by a user/consumer using an electronic device having capability (i) to receive and transmit messages, (ii) accept input via a user interface, and (iii) display messages on an electronic display, the method comprising the steps of:
a. forming a printed page advertising medium;
b. inserting at least one specialized main body heading or theme related to a specific category of goods or services on said printed page, or a non-specific category that can be all inclusive.
c. selecting at least two non-competing advertisement blocks located on said printed ½ page being directly next to one another, said non-competing advertisements falling within said specific category of goods or services of said specialized main body heading; and
d. providing a cyber content section containing said cyber content on said printed page directly next to said advertisements, wherein said cyber content section includes a unique website link associated with each of said non-competing advertisements.
